(19) United States
(12) Patent Application Publication
(10) Pub. No.: US 2007/0078691 A1
(43) Pub. Date: Apr. 5, 2007

(54) Vacant seat reservation system

(75) Inventor: Masaki Wakabayashi, Yokohama (JP)

Correspondence Address: MCDERMOTT WILL & EMERY LLP, 600 13TH STREET, N.W., WASHINGTON, DC, 20005-3096, US

(73) Assignee: HITACHI, LTD.

(21) Appl. No.: 11/471,647

(22) Filed: Jun. 21, 2006

(30) Foreign Application Priority Data
Oct. 3, 2005 (JP) 2005-289511

(51) Int. Cl. G06Q 10/00

(52) U.S. Cl. 705/5

(57) ABSTRACT

With using a boarding planned station name 211 registered by a portable information terminal 2, an information processing apparatus 4 produces vacant seat forecast information 410, including an alighting planned station name therein. While displaying this vacant seat forecast information on a terminal display portion 22, a seat-setup vacant seat information display portion 33, or a vacant seat display portion 34, a user of public transportation facilities can foresee a vacant seat. Also, she/he can reserve the seat by transmitting a user ID 215 to the communicator portion 40. Further, by changing constituent elements of the vacant seat forecast information into, not the alighting planned station name, but an arrival estimation time 420 or an alighting order 421, it is possible to promote the goodwill of providing the information for forecasting the vacant seat. Also, by use of a device, which can easily change the contents of display, as the display portion, the system can be diverted into other route, easily.

### CLAIM OF PRIORITY

The present application claims priority from Japanese patent application No. JP 2005-289511 filed on Oct. 03, 2005, the contents of which is hereby incorporated by reference into this application.

### BACKGROUND OF THE INVENTION

The present invention relates to a method for disclosing information relating to getting on and off a car, and a method for booking or reserving a seat, for example, in facilities for public transportation.

In the facilities for public transportation, such as, a bus jolting hard during the traveling thereof, for example, for an old person and/or a handicapped person, it is preferable to have a seat therein, for the purpose of protecting them from injury caused due to such jolting. However, such the facilities for public transportation are crowded with peoples, depending upon the date and/or time, therefore it is impossible for all the passengers to have their own seats. For example, when a vacant seat is caused at a certain bus stop or a station, for example, but if the passenger stands near to that vacant seat, the seat is occupied by other passenger. At the end, without a favor or goodwill of the other passengers, the passenger who should take a seat cannot have the seat to sit thereon.

However, there is already known a technology (the following Patent Document 1), for a passenger already having the seat to indicate a station where she/he will get off, so as notice it commonly, with using an apparatus of sliding method, which is provided at each of the seats of the bus, for keeping fairness of taking a seat.

Also, the following Patent Document 2 discloses a system for providing the condition of vacant seats, which is calculated from information relating to the stations where the passengers get off the car, through the Internet, so that a passenger can make reservation of the seat on the board, however with this, it is impossible for the passenger to make the seat reservation before she/he get in the car.

Further, the following Patent Document 3 discloses a system, in which the passenger having the seat sends the information relating to the station where she/he will get off the car, so as to calculate out an estimated waiting time for a vacant seat, however with this, there is no description is included, about the reservation of the seats.

Finally, the following Patent Document 4 discloses a system, in which the information relating to a name of the station where the passenger will get off the car (i.e., an alighting station name) is transmitted from ticket information, to light up the alighting station name or a lamp, etc.; thereby making the vacant seat information known to everyone. However, this fails to mention the reservation for seats.

[Patent Document 1] Japanese Patent Laying-Open No. 2002-154431 (2002);

[Patent Document 2] Japanese Patent Laying-Open No. 2004-110508 (2004);

[Patent Document 3] Japanese Patent Laying-Open No. 2004-86471 (2004); and

[Patent Document 4] Japanese Patent Laying-Open No. Hei 9-190485 (1997).

### SUMMARY OF THE INVENTION

As was described in those Patent Documents mentioned above, it is possible to expect or forecast the vacant seat, by making the station names, where the passengers will get off the car, known to everybody. However, with the Patent Document 1, there is a drawback, which will be mentioned below.

First of all, there is necessity of walking around to watch the display of the station name where the passengers will get off the car, relating to all, of the seats during a stop of the car, and it is difficult, in particular, when the car is crowded. Also, the act itself, i.e., walking around to watch the display of the station name where the passengers will get off the car, it is dangerous.

Second, since for the passenger taking the seat, it is necessary to disclose or reveal her/his privacy, i.e., the station name where she/he will get off the car, during time until when she/he gets off the car, therefore there is an anxiety that it is difficult to promote the goodwill of others, providing the expected information of vacant seats.

Finally, the display of the station name is made of carving or in print, and therefore it is difficult to divert it to other routes or lines.

According to the present invention, accomplished by taking the drawbacks mentioned above into the consideration thereof, according to the present invention, an object thereof is to provide a system, enabling a user to make a forecast of the situation or condition of vacant seats from a remote, and thereby to make a reservation for the vacant seat or a possible seat which will be vacant in future, from the remote. Also, other object according to the present invention is to provide a system for promoting the goodwill of the other passenger to provide the expected information of vacant seats, without continuing the unnecessary exposure of the privacy. And further other object, according to the present invention, is to provide a system, so that the transportation facility comprising such the means for achieving the object mentioned above can be diverted into other lines, easily.

For dissolving such the problems as was mentioned, the present invention provide a vacant seat reservation system, comprising the following means.

First of all, one of the objects according to the present invention, i.e., a device for enabling a user to reserve the vacant seat from a remote, while forecasting the vacant seat condition, can be accomplished by the following means.

A portable information terminal, according to the present invention, comprises a terminal communicator portion for making communication with other equipments, and a display portion for displaying the vacant seat information thereon. By means of a present condition obtaining means thereof, the terminal communicator portion receives an alighting planned station name registering means, which is transmitted by a registering method transmitting means, from at least any one of a communicator portion provided at a bus stop or station, a communicator portion provided at an entrance of the public transportation facility, or a communicator portion of an information processing apparatus, which is provided in the transportation facility or on a network.

The user of the portable information terminal registers the alighting planned station name into a memory portion of the portable information terminal, by using the alighting planned station name registering means. A communicator portion receiving the registered alighting planned station name, which is transmitted from the terminal communicator portion of the portable information terminal, transmits the alighting planned station name received to the portable information terminal having the present condition obtaining means, as to be a vacant seat forecast information. The user of the portable information terminal having the present condition obtaining means can notice the vacant seat forecast information received through the communicator portion. At the same time, by displaying those vacant seat forecast information on a display portion provided in the public transportation facility, it is possible to notice the vacant seat forecast information to the users of the public transportation facility.

The user customer waiting the vacant seat sets up the alighting planned station name with using the alighting planned station name registering means of the portable information terminal, and transmits the user ID, and depending upon necessity thereof, at least any one of a public transportation facility ID for discriminating one of the public transportation facilities, the seat position information, or the boarding planned station name, to the communicator portion of the public transportation facility. With this, the information processing apparatus, producing the vacant seat forecast information for the seat within a specific area, conducts process for seat reservation by using the information mentioned above, and renews the vacant seat forecast information. This vacant seat forecast information is distributed to the communicator portion of other information equipments. For example, the portable information terminal of the user of the public transportation facility can receive the vacant seat forecast information, which is renewed by the present condition obtaining means. At the same time, the renewed vacant seat forecast information may be displayed on the display portion provided in the public transportation facility.

With doing this, it is possible to make reservation for a seat, which is vacant or will be vacant in future, on the public transportation facility, with using the portable information terminal.

Also, the second object according to the present invention, i.e., a device for promoting the user to provide the vacant seat forecast information without continuing unnecessary exposure of privacy, can be accomplished by the following means.

Among the means for achieving the first object mentioned above, not using the alighting planned station name as the vacant seat forecast information, but it is constructed with at least any one of the arrival estimation time calculated from the alighting planned station name by using an arrival time calculating means, or an alighting order calculated by an alighting order calculating means.

With doing this, the user of the portable information terminal comprising the present condition obtaining means, or the user noticing the vacant seat forecast information through the display portion of the public transportation facility can foresee the vacant seat with an aid of, not the alighting planned station name, but the arrival estimation time and/or the alighting order; therefore, it is possible to protect the privacy by a certain degree.

Finally, the third object according to the present invention, i.e., a device for making diversion into other routes or lines easy, can be accomplished by the following means.

On the display portion of the public transportation facility, the vacant seat forecast information is displayed by using a device, which can change the display contents arbitrarily.

With doing so, since the change of the display contents can be made easy even in the case that the public transportation facility travels on other line, therefore the means for dissolving such the problems mentioned above can be diverted into other route or line.

According to the present invention, it is possible to increase the convenience relating to use of the public transportation facilities.

### BRIEF DESCRIPTION OF THE SEVERAL VIEWS OF THE DRAWING

Those and other objects, features and advantages of the present invention will become more readily apparent from the following detailed description when taken in conjunction with the accompanying drawings wherein:

FIG. 1 is a block diagram for showing an outline of functional structures of a system, according to an embodiment of the present invention;

FIG. 2 is a flowchart for use in a public transportation facility;

FIG. 3 is a sequence diagram of transmission of data, in particular, when a passenger makes renewal before boarding on a car without reservation, when boarding on a car without reservation, and when taking a seat without reservation;

FIG. 4 is a sequence diagram of transmission of data, in particular, when the passenger makes a reservation before boarding, when boarding on a car after making the reservation, and when taking a seat with reservation; and

FIG. 5 is a sequence diagram of transmission of data, in particular, when the passenger makes a reservation when getting on a car, when making a reservation on board, and when alighting a car.

### DETAILED DESCRIPTION OF THE INVENTION

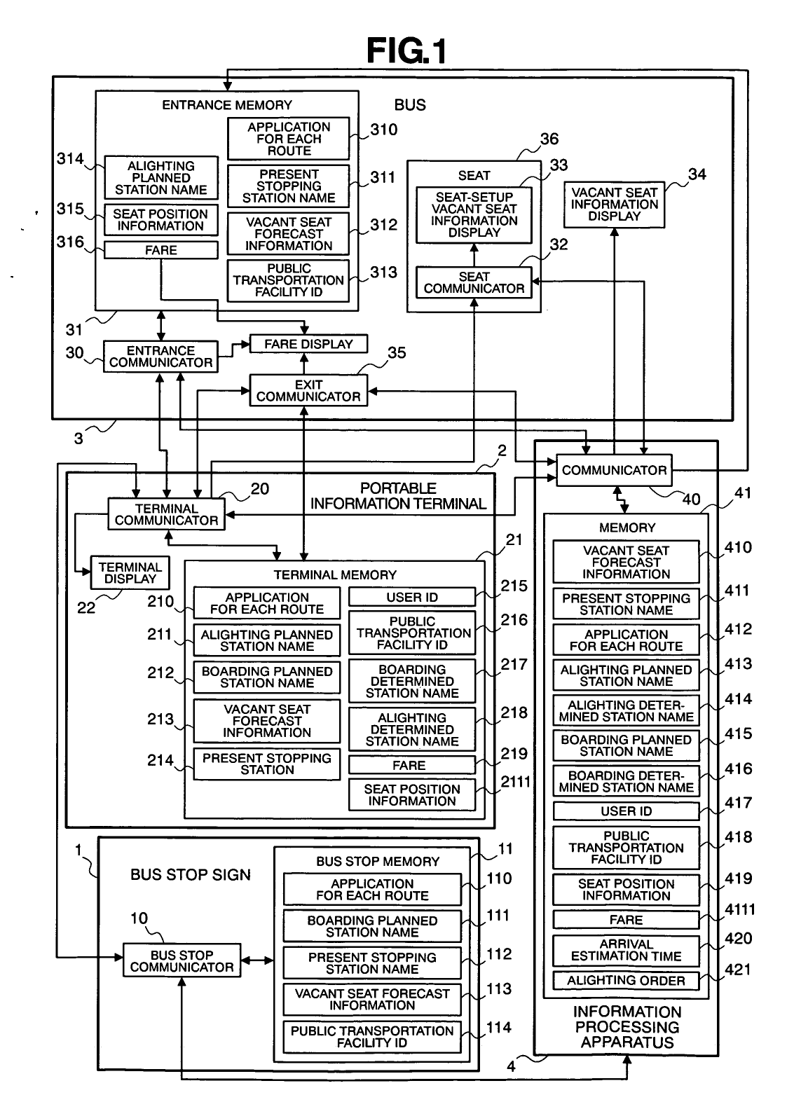

Hereinafter, embodiments according to the present invention will be fully explained by referring to the attached drawings, i.e., FIGS. 1 to 5.

Although the explanation will be made on an example when being applied into a bus, for example, as the public transportation facilities, however the present invention is should not be restricted to this, and it may be applied into a streetcar or an electric tram, other than that.

FIG. 1 is a function block diagram for showing the functional structures of a vacant seal information display system, according to the present invention.

A bus stop mark or sign 1 comprises a bus stop communicator portion 10 for communicating with other communicator portions, a bus stop memory portion 11 for storing information therein, and a line discriminator portion for discriminating a route or line of the bus, which will arrive at the said station, such as, a route map and/or a time table, for example.

The bus stop communicator portion 10 is a device, which can communicate with a terminal communicator portion 20 of a portable information terminal 2 and a communicator portion 40 of an information processing apparatus 4, and also enables to transmit the information stored in the bus stop memory portion 11, which will be mentioned below, or send the information received by the bus stop communicator portion 10 to the terminal communicator portion 20 and/or the communicator portion 40, as it is.

The bus stop memory portion 11 is a device, which can store an application 110 for each of the routes (i.e., an application for each route), a station name 111 where a passenger is planning to get on or board a car (i.e., a boarding planned station name), a station name 112 where the bus stops at the present time (i.e., a present stopping station name), information 113 for forecast of a vacant seat (i.e., vacant seat forecast information), an ID of a public transportation facility (i.e., a public transportation facility ID), etc., therein.

The application for each route 110 is software for providing at least one of a means A1 for registering a station name where a passenger is planning to get off or alight a car (i.e., an alighting planned station name registering means), a vacant seat reservation means A2, a means A3 for registering a station name where a passenger is planning to get on or board a car (i.e., a boarding planned station name registering means), a fare calculator means A4, a route decision means A5, and a means A6 for determining stoppage at a station where a passenger is planning to get off or alight a car (i.e., an alighting planned station stoppage deciding means), which will be mentioned later. Also, the application for each route 110 may be in such a form that it includes the boarding planned station name 111, the present stopping station name 112, the vacant seat forecast information 113, or the public transportation facility ID 114 therein, to be stored into the bus stop memory portion 11, which will be mentioned below, as the information being necessary for achieving the means A1-A6 mentioned above.

The boarding planned station name 111 indicates a but stop name or the station name, which is uniquely given to the bus stop where the bus stop mark or sign 1 is provided.

The present stopping station name 112 indicates the name of the bus stop or station, where the bus 3 has passed through just before, or where it is stopping at, presently.

The vacant seat forecast information 113 is the information, which is obtained through integration or unification of the vacant seat forecast information for each of the seats in the bus 3, for all of the seats within a specific area, by means of an individual car getting on/off information integrating means A7, which will be mentioned later. A user of the public transportation facility can make a reservation or a forecast, for a vacant seat or a seat that will be vacant in future, by referring to this vacant seat forecast information. The vacant seat forecast information for each of the seats is built up with at least one of a condition of the present vacant seats, or the alighting planned station name of a passenger who makes the reservation for a seat, the alighting planned station name, an arrival estimation time until when the car arrives at the alighting planned station name, and a relative order for the passengers who have the seats, when they get off the car.

The public transportation facility ID 114 is identification information for discriminating a facility of the public transportation facilities, uniquely, and for example, a user uses it before; she/he gets on the bus 3, for the purpose of discriminating the facility, in which the seat reservation will be made.

The portable information terminal 2 comprises the terminal communicator portion 20, and also a terminal display portion 22. And, the portable information terminal 2 may comprise at least any one means, among the alighting planned station name registering means A1, the vacant seat reservation means A2, the boarding planned station name registering means A3, the fare calculator means A4, the route decision means A5 and the alighting planned station stoppage deciding means A6, and further a present condition obtaining means A8 and an application execution means A10.

The terminal communicator portion 20 is a device enabling to communicate with the bus stop communicator portion 10, an entrance communicator portion 30, a seat communicator portion 32, an exit communicator portion 35, and the communicator portion 40, so as to transmit information therebetween.

A terminal memory portion 21 is a device, for enabling to memorize therein, an application separated for each route (i.e., an application for each route) 210, an alighting planned station name 211, a boarding planned station name 212, a vacant seat forecast information 213, a present stopping station name 214, a user ID 215, a public transportation facility ID 216, a boarding determined station name 217, an alighting determined station name 218, a fare 219, and a seat position 2111, etc.

The application for each route 210 is software, being similar to the application for each route 110. Thus, it receives the application for each route and the present condition data, which are renewed, from the bus stop communicator portion 10, the entrance communicator portion 30, which will be mentioned later, and the communicator portion 40 of the information processing apparatus 4, by means of the present condition obtaining means A8. With using the applications for each route and the present condition data, which are received from those communicator portions, it is possible to renew the application for each route 210 stored within the terminal memory portion 21, and also to obtain newest information relating to the seats of the public transportation facility. Also, the application for each route 210 may be in a form, including therein the information to be stored into the terminal memory portion 21, i.e., the alighting planned station name 211, the boarding planned station name 212, the vacant seat forecast information 213, the present stopping station name 214, the user ID 215, the public transportation facility ID 216, the boarding determined station name 217, the alighting determined station name 218, the fare 219, and the seat position 2111, which will be mentioned below.

The alighting planned station name 211 is a name of the station where the user is planning to get of f the car. The alighting planned station name 211 is stored into the terminal memory portion 21 by means of the alighting planned station name registering means A1.

The boarding planned station name 212 indicates a name of the station where the user is planning to get on the car. Thus, in many cases, it may be same to that of the get on planning station 111 unique to the bus stop 1, where the user receives the application for each route 110. It is stored into the terminal memory portion 21 by means of the vacant seat reservation means A2.

The vacant seat forecast information 213 is the same information to the vacant seat forecast information 113 mentioned above, and it can be renewed by means of the present condition obtaining means A8.

The present stopping station name 214 is the same information to the stopping station name 112 mentioned above, and it can be renewed by means of the present condition obtaining means A8.

The user ID 215 is the identification information for discriminating the user of the public transportation facility, uniquely. The user ID 215 may be the identification information that is given to the portable information terminal, or that the public transportation facility gives, as far as possible to discriminate the user uniquely, with it.

The public transportation facility ID 216 is the same information to the public transportation facility ID 114, as was mentioned above.

The boarding determined station name 217 is a name of the station that the terminal communicator portion 20 receives from the entrance communicator portion 30, when the user gets on the bus 3. Depending upon the user, the boarding determined station name 217 may not be coincident with the boarding planned station name 212, and therefore it is the information necessary for preventing the passenger from unfair riding on the car, and/or for calculating the fare 219, correctly.

The alighting determined station name 218 is a name of the station that the terminal communicator portion 20 receives from the exit communicator portion 35, when the user gets off the bus 3. The alighting determined station name 218 is used in combination with the boarding determined station name 217, so as to determine the fare 219 for the section that the user rides on the car.

The fare 219 is an expense necessary for the section, starting from a start point where the user gets on the car, i.e., the boarding determined station name 217, up to an end point where the user gets off the car, i.e., the alighting determined station name 218, and it is calculated out by means of the fare calculator means A4.

The seat position 2111 is identification information for uniquely discriminating the seat in the public transportation facility.

The terminal display 22 is a device for displaying the information stored into the terminal memory portion 21 to the user of the portable information terminal 2.

The bus 3 is one example of the public transportation facility, which travels periodically along a specific route or line. The bus 3 is a public transportation facility, having the entrance communicator portion 30, an entrance memory portion 31, the seat communicator portion 32, and a seat-setup vacant seat information display portion 33, a vacant seat information display portion 34, the exit communicator portion 35, and a seat 36. It may also include therein, at least any of the fare calculator means A4, the route decision means A5, the alighting planned station stoppage deciding means A6, and a subscriber determining means A14.

The entrance communicator portion 30 is a device for enabling to communicate with the terminal communicator portion 20 and/or the communicator portion 40, and it is provided at an entrance of the bus.

The entrance memory portion 31 is a device able to store an application separated for each route (i.e., an application for each route) 310, a stopping station name 311, and vacant seat forecast information 312, therein.

The application for each route 310 is software similar to the application for each route 110, however it may be in a form, including at least any one of the present stopping station name 311, the vacant seat forecast information 312, a public transportation facility ID 313, an alighting planned station name 314, seat position information 315, and a fare 316.

The present stopping station name 311 is a name of the station, at which the but is stopping at present, or a name of the station that the bus 3 has passed through just before, which is obtained by means of a stopping station detector means A9. The present stopping station name 311 is stored by the name of the boarding determined station name 217 in the terminal memory portion 21, when it is sent to the terminal communicator portion 20 through the entrance communicator portion 30.

The vacant seat forecast information 312 is the similar information to the vacant seat forecast information 113 or 213 mentioned above. Vacant seat forecast information 410 stored in a memory portion 41 is transmitted from the communicator portion 40 to the entrance communicator portion 30, while entrance communicator portion 30 receiving thereof stores it into the entrance memory portion 31, once, and thereby renewing the vacant seat forecast information 213, which is stored in the terminal memory portion 21.

The public transportation facility ID 313 is the information similar to the public transportation facility ID 114 or 216 mentioned above.

The alighting planned station name 314 is the information similar to the alighting planned station name 211 mentioned above.

The seat position information 315 is the information similar to the seat position information 2111 mentioned above, and it is memorized into the entrance memory portion 31 through the entrance communicator portion 30 or the communicator portion 40.

The fare 316 is an estimated fare, which is obtained through calculating the expenses necessary for use during the section, starting from a start point of the present stopping station name 311 up to an end point of the alighting planned station name 314 receiving from the terminal communicator portion 20. Transmission of the fare 316 to the terminal communicator portion 20 through the entrance communicator portion 30 renews the fare 219, whish is stored in the terminal memory portion 21.

The seat communicator portion 32 is a device, which can communicate with the terminal communicator portion 20 and/or the communicator portion 40, and it is provided for the every seat.

The seat-setup vacant seat information display portion 33 is a device for displaying the vacant seat forecast information thereon, for each of the seats, and this is also provided for the every seat. By displaying at least anyone of an individual alighting planned station name 413, an arrival estimation time 420, and a getting off or alighting order, on said display portion, it is possible for the user waiting a vacant seat to foresee the vacancy thereof.

The vacant seat information display portion 34 is a device for displaying the getting on/off information relating to all of the seats within a specific area in the bus 3, i.e., the vacant seat forecast information 312, thereon. Irrespective of presence of the seat-setup vacant seat information display portion 33 mentioned above, which is provided for each of the seats, if the vacant seat information display portion 34 is provided within an inside of the bus or an outside thereof, it is possible for the user waiting the vacant seat to foresee the vacancy thereof in future, by displaying the vacant seat forecast information 410 on the vacant seat information display portion 34.

The exit communicator portion 35 is a device, which can communicate with the terminal communicator portion 20 and/or the communicator portion 40, and it is provided at an exit of the bus, so as to conduct transmission of data for calculating out the fare.

The seat 36 indicates a seat setup within an inside of the bus 3, on which the user sits, and in case where the seats are in plural number thereof, they are discriminated with using a presentation made by means of the seat position information 2111. The seat 36 may also comprise at least any one of the seat communicator portion 32 and the seat-setup vacant seat information display portion 33.

A fare display portion 37 is provided at least in either the entrance or the exit of the bus 3, and it displays the fare 316 for the user to confirm the necessary expense thereon, or displays a fare 4111 through the entrance communicator portion 30 or the exit communicator portion 35.

The information processing apparatus 4 comprises the communicator 40 for communicating with other equipments and a memory portion 41 for storing information therein, and it may be provided within an inside of the bus 3 or an outside thereof. The information processing apparatus 4 may comprise at least any one of the fare calculator means A4, the route decision means A5, the alighting planned station stoppage deciding means A6, an arrival time calculator means A11, a car get-off order calculator means A12, an application producing means A13, and a subscriber determining means A14.

The communicator portion 40 is a device, which can communicate with the bus stop communicator portion 10, the terminal communicator portion 20, the entrance communicator portion 30, the seat communicator portion 32 and the exit communicator portion 35, etc.

The memory portion 41 is a device, which can store the vacant seat forecast information 410, a present stopping station name 411, an application 412 separated for each route (i.e., an application for each route), an alighting planned station name 413, an alighting determined station name 414, a car boarding planned station name 415, a boarding determined station name 416, a user ID 417, a public transportation facility ID 418, a seat position information 419, and the fare 4111 therein.

The vacant seat forecast information 410 is the information similar to the vacant seat forecast information 113 mentioned above. The vacant seat forecast information 410 is the information, which is obtained through integrating at least any one of the alighting planned station name 413 relating to each of the seats within an entire of a specific area or region, the alighting determined station name 414, the boarding planned station name 415, the boarding determined station name 416, and the user ID 417, with the public transportation facility ID 418, by means of the car get on/off information integrating means A7. Also, the alighting planned station name 413 may be substituted by at least any one, i.e., the arrival estimation time 420 calculated by the arrival time calculator means A11, or a get-off or alighting order 421 calculated by the alighting order calculator means A12, in the place thereof.

The present stopping station name 411 is the information similar to the stopping station name 112 mentioned above, and since changing dynamically, it is renewed from time to time and stored into the memory portion 41, by means of the stopping station detector means A9.

The application for each route 412 is software similar to the application for each route 110 mentioned above, and it can display the vacant seat forecast information 410. The application for each route 412 is produced by the information processing apparatus 4 through the application production means, to be stored into the memory portion 41, and it is transmitted through the communicator portion 40 every time when it is renewed. Or, it may be in such a form that the present condition data to be used by the application for each route 412 is transmitted through the communicator portion 40.

The alighting planned station name 413 is the information similar to the alighting planned station name 213 mentioned above, and it is received through the communicator portion 40.

The alighting determined station name 414 is equal to the alighting determined station name 218 or the present stopping station name 411 mentioned above.

The boarding planned station name 415 is the information similar to the boarding planned station name 215 mentioned above, and it is received through the communicator portion 40.

The boarding determined station name 416 is equal to the boarding determined station name 217 or the present stopping station name 411 mentioned above.

The user ID 417 is the information similar to the user ID 215 mentioned above, and it is received through the communicator portion 40.

The public transportation facility ID 418 is the information similar to the public transportation facility ID 313 mentioned above, and it is produced and managed by the information processing apparatus 4. With using the public transportation facility ID 418, since it is easy to discriminate the facility of the bus 3, therefore the vacant seat forecast information 410 displayed on the terminal 22 can be discriminated from that of the other facilities, easily.

The seat position information 419 is the information similar to the seat position information 2111, and it is managed by the information processing apparatus 4 relating to at least any one of the alighting planned station name 413, the alighting determined station name 414, the boarding planned station name 415, the boarding determined station name 416 is equal to the boarding determined station name 217, and the user ID 417.

The fare 4111 is calculation of the expense necessary for use of the bus during the section, from a start point of either the boarding planned station name 415 or the boarding determined station name 416 up to an end point of the alighting planned station name 413 or the alighting determined station name 414. The fare 4111 is outputted on the terminal display portion 22 as the fare 219, or is outputted on the display portion 37 of the bus 3, thereby to be noticed to the user in the form of the fare or the determined fare. Also, it is transmitted from the exit communicator portion 35 to the terminal communicator, to be used for deleting an amount that the fare 4111 displays.

The arrival estimation time 420 indicates the time estimated from the present time up to the time when the user arrives at the alighting planned station name 413 within the specific area or region, and it is calculated by the arrival time calculator means A11.

The alighting order 421 is indicative of the order of getting off the car by a relative value, for the respective users within the specific area or region, and it is calculated by the alighting order calculator means A12.

The alighting planned station name registering means A1 is a means for storing a name of the station where the user of the bus 3 is planning to get off the car, into the memory portion 21. The said means may be in such a form that the application for each route 210 provides it.

The vacant seat reservation means A2 is a means for selecting the information to be transmitted, i.e., the public transportation facility ID, the seat position information and the boarding planned station name, depending on the necessity thereof, i.e., an address of transmission is the bus stop communicator portion 10, the entrance communicator portion 30, the seat communicator portion 40, or the communicator portion 40, and finally transmitting them to the communicator portion 40 of the information processing apparatus 4, thereby transmitting the information for the user of the bus 3 to make the reservation for the seat, which is vacant or will be vacant in future.

The boarding planned station name registering means A3 is a means for storing a name of the station where the user of the bus 3 gets on the car, into the memory portion 21. The said means maybe in such a form that the application for each route 210 provides it.

The fare calculator means A4 is a means for calculating an expense necessary for riding on the car, during the section from a start point of the boarding planned station name or the boarding determined station name up to an end point of the alighting planned station name or the alighting determined station name, and it may be in such a form that the application for each route 210 provides it. Outputting a result of calculation on the fare display portion 37 or the terminal display portion 22 enables the user to affirm the fare before she/he gets on or off the car, in particular, on the bus route adopting a variable fare system depending on traveling distance, thereby knowing excess and deficiency of many in hand.

The route decision means A5 is a means for determining on whether the bus 3 arriving at a bus stop is the bus of the same route or line or not, corresponding to the public transportation facility ID 216, by comparing the public transportation facility ID 216 stored in the terminal memory portion 21 with the public transportation facility ID 313 stored in the entrance memory portion 31 or the public transportation facility ID 417, and it may be in such a form that the application for each route 210 provides it.

The alighting planned station stoppage deciding means A6 is a means for determining on whether the alighting planned station name 211 stored in the terminal memory portion 21 is included or not, within all the bus stops where the public transportation facility ID 313 stored in the entrance memory portion 31 or the public transportation facility ID 417 provide the stoppage, and it may be in such a form that the application for each route 210 provides it.

The getting on/off information integrating means A7 is a means for integrating or unifying at least any one of the alighting planned station name 413, the alighting determined station name 414, the boarding planned station name 415, the boarding planned station name 416, the user ID 416, the seat position information 418, the fare 4111, and the arrival estimation time 420, for all of the seats within the specific area or region, and thereby producing the vacant seat forecast information 410.

The present condition obtaining means A8 is a means for receiving the present condition data to be used in the renewed applications for each route 110, 310 or 412, or the said application for each route, through the terminal communicator portion 20, and it may be in such a form that the application for each route 210 provides it.

The stopping station detector means A9 is a means for detecting a name of the bus stop where the bus is now stopping or it stopped just before, with using at least any one of the present position, the present velocity, and the present time by means of the GPS, or a history of the conventional traveling time.

The application execution means A10 is a means for executing the application for each route 210, so as to provide at least any one of the alighting planned station name registering means A1, the vacant seat reservation means A2, the boarding planned station name registering means A3, the fare calculator means A4, the route decision means A5, and the present condition obtaining means A8.

The arrival time calculator means A11 is a means for calculating the time estimated to be necessary until when the bus arrives at the alighting planned station name 413 from the present position, with using the present stopping station name 411 obtained by the stopping station name detector means, the present position, the present velocity, and the present time, which are obtained by means of the GPS, and/or the history of the conventional traveling time, etc.

The alighting order calculator means A12 is a means for maintaining the result of calculation for the estimated arrival time by means of the arrival time calculator means A11, and thereby distributing an order from the seat having a less time remaining. The information processing apparatus 4 transmits the alighting order to the seat communicator portion 32 of each of the seats, and the seat-setup vacant seat information display portion 33 of the each seat displays the said order received thereon. In this manner, displaying or knowing the order of coming to be vacant to everyone, relating to the entire of the seats, it is possible for the user waiting a vacant seat to expect a future vacant seat.

The application producing means A13 is a means for producing the application for each route 412, with using at least any one of the vacant seat forecast information 410 and the present stopping station name 411, in the application format being executable by the application executing means A10. Also, the function of producing the present condition data to be used by the application for each route 412 may be included within the said means A12.

The subscriber determining means A14 is a means for determining on whether the bus arriving at the bus stop provides the seat or not, which the user made reservation thereof, by comparing the user ID 417 that is finally stored in the memory portion 41 through the communicator portion 40 with the user ID 215 within the terminal memory portion.

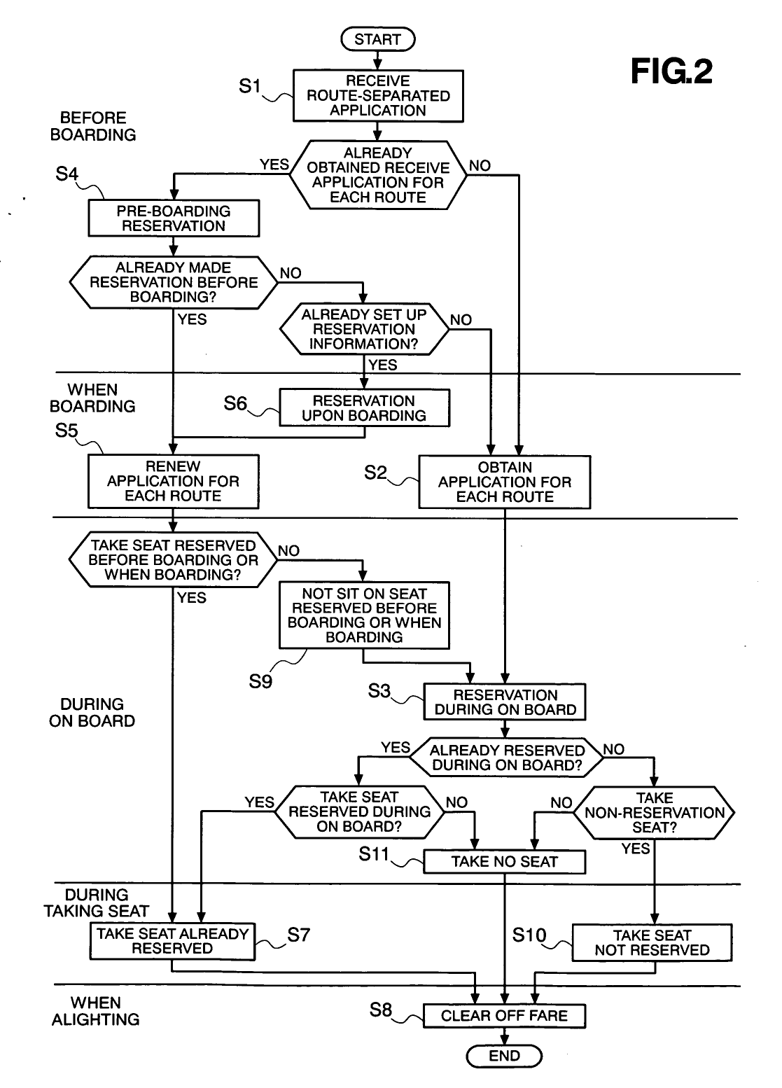

FIG. 2 is a flowchart for showing events, which are generated from the time before the passenger gets on a car up to the time when she/he get of f the car, when she/he uses the public transportation facility. Roughly dividing, those events can be classified into five (5), i.e., before boarding, when boarding, during on board, during having a seat, when alighting. First of all, before boarding, it sometimes comes into such a condition (S1) as will be shown below.

S1 is the condition of being able to receive the application for each route. Herein, in case when the application for each route cannot be obtained, then a step advances into S2, while it advances into S4 when it can be obtained.

S2 is the condition of obtaining the application for each route when the passenger gets on the car.

S3 is a condition where reservation can be made, for a vacant seat on board. In case where the passenger makes the reservation for the vacant seat on board and sits on the seat, then it advances into S7. Although making the reservation for a vacant seat on board, however if she/he does not sit on the seat yet, then it advances into S11.

On the other hand, if the passenger makes no reservation for a vacant seat on board, but she/he sit on a vacant seat, then it advances into S10. Also, without reservation, if she/he does not sit on the vacant seat, then it advances into the S11.

S4 is a condition where the reservation can be made for a vacant seat before boarding, with using the application for each route obtained. Then, when the reservation is made for the vacant seat before boarding, it advances into S5. In case where no reservation is made for the vacant seat before boarding, and if the information necessary for reservation of the vacant seat is already set up into the application, then it advances into S6. Without such setup, it advances into S2.

S5 is a condition where renewal is made upon receipt of the application for each route when boarding. If the passenger sits on a seat reserved before boarding or when boarding, the step advances into S7. Or, if she/he does not take the seat, then the step advances into S9.

S6 is a condition where the reservation can be made when boarding, and if the passenger makes the reservation when boarding, then it advances into S5.

S7 is a condition where the passenger already took the seat, which she/he made reservation. At the same time, it is also a condition of being able to transmit the alighting planned station name. When alighting, it advances into S8.

S8 is a condition for the passenger to clear off the fare when she/he gets off the car, in particular, on the public transportation facilities applying the deferred payment system therein, and she/he can get off the car after completing this.

S9 is a condition where the passenger does not sit on the seat reserved yet, and it can advance into the condition S3 where the reservation can be made for the vacant seat on board.

S10 is a condition where the passage could have a seat without reservation. At the same time, it is in the condition of being able to transmit the alighting planned station name. When alighting, it advances into S8.

S11 is a condition where finally the passenger cannot have a seat, irrespective of having reservation or not, it advances into S8 when she/he gets off the car. However, if being transited into this condition, it is advanced into the S3 when she/he newly makes the reservation on board.

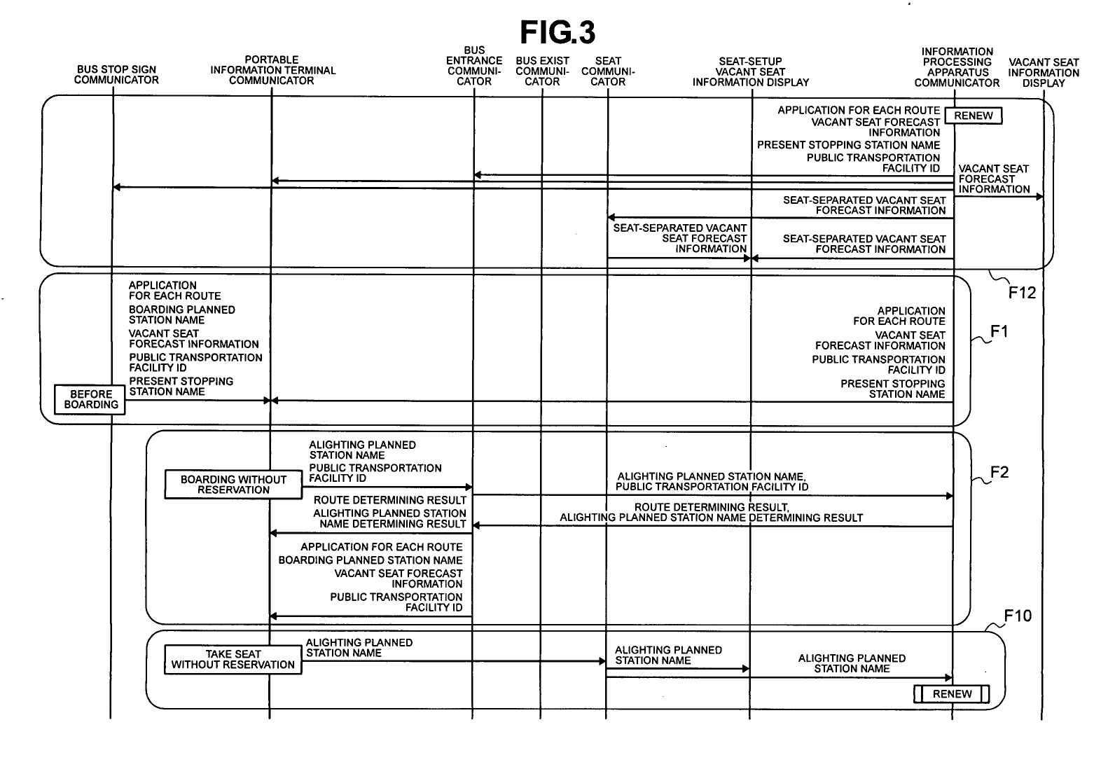

FIGS. 3, 4 and 5 show sequences for transmitting data among the bus stop communicator portion 10, the terminal communicator portion 20, the entrance communicator portion 30, the seat communicator portion 32, the vacant seat information display portion 34, the exit communicator portion 35, the seat-setup vacant seat information display portion 33, and the communicator portion 40 of the information processing apparatus 4, in the events generated when using the public transportation facility shown in FIG. 2. Upon basis of those sequence diagrams, explanation will be made on the embodiment of the present invention.

FIG. 3 shows therein a sequence F12 when making renewal upon the vacant seat forecast information, a sequence F1 under the condition before boarding shown in FIG. 2, and also a sequence F10 under the condition S10 where the passenger takes a seat without reservation.

F12 is a sequence diagram showing processes for renewing the vacant seat forecast information 410 and the application for each route 412.

First of all, the application for each route 412 is produced by the application producing means A13. The vacant seat forecast information 410, the present stopping station name 411 and the public transportation facility ID 418, which are renewed, may be included in this, in the form thereof.

First, the communicator portion of the information processing apparatus 4 transmits the application for each route 412 to the but stop communicator portion 10, so as to renew the application for each route 110 stored in the bus top memory portion 11. It is also possible to transmit the present stopping station name 411 of the bus stop, which the bus has passed through just before, the vacant seat forecast information 410 and the public transportation facility ID 418; however, those may be the information to be included or not, in the application for each route 412.

Second, the communicator portion 40 of the information processing apparatus 4 makes renewal upon the application for each route 310, the present stopping station name 311 and the vacant seat forecast information 312 in the entrance memory portion 31, through either one method; i.e., transmitting at least any one of the application for each route 412, the vacant seat forecast information 410 and the present stopping station name 411, to the entrance communicator portion 30, or renewing the entrance memory portion 31, directly.

Third, the communicator portion 40 of the information processing apparatus 4 transmits at least one of the vacant seat forecast information 410 and the present stopping station name 411, to the terminal communicator portion 20, so as to renew the vacant seat forecast information 213 and the present stopping station name 214, which are stored in the terminal memory portion 21. Also, those may be the information to be included or not, in the application for each route 412.

Lastly, in case where the vacant seat information display portion 34 is provided within the bus 3, the communicator portion 40 of the information processing apparatus 4 renews the display on the vacant seat information display portion 34, with using the vacant seat forecast information 410.

Also, the seat-setup vacant seat information display portion 33 in the bus 3, the information processing apparatus 4 picks up or extract the vacant seat forecast information for each of the seats corresponding thereto, with using the seat position information 418, from the vacant seat forecast information 410 stored in the memory portion 41. With doing this, the display on the seat-setup vacant seat information display portion 33 is renewed or the vacant seat forecast information for each seat is transmitted to the seat communicator portion 32, and thereby the seat communicator portion 32 renews the display on the seat-setup vacant seat information display portion 33.

With doing so, for the user waiting a vacant seat can expect a future vacant seat.

F1 is a sequence before boarding. First, the user specifies a route or line, on which she/he is planning to get on, judging from a route map and/or a time table, which is/or displayed on the bus stop mark provided at the bus stop of the bus 3. For example, the bus stop communicator portion 10 is provided for each of the route map and/or the time table of the bus stop sign 1, and therefore, it can communicate with the communicator portion 20 of the portable information terminal 2, which the user owns. As a result of this communication, the portable information terminal 2 can receive the application for each route 110 from the but stop communicator portion 10, so as to store it into the memory portion 21 as the application for each route 110. At the same time, it also can receive at least any one of the boarding planned station name 111 having received the application for each route 110, the present stopping station name 112 at which the bust has stopped just before, the vacant seat forecast information 113 of the bus, which will arrive in future, and the public transportation facility ID 114, to store it/them into the terminal memory portion 21.

Also, other than that mentioned above, it is possible to receive the application for each route 412 corresponding to an object route, through the communicator portion 40 of the information processing apparatus 4, thereby storing it into the terminal memory portion 21 to be the application for each route 210. In this instance, it is possible to receive at least any one of the vacant seat forecast information 410, the present stopping station name 411, or the public transportation facility ID 418, thereby storing it into the terminal memory portion 21.

Having received such the information, the user waits an arrival of the bus 3 of the object route in the vicinity of the bus stop sign 1 thereof. With using the application for each route 210 received by the portable information terminal 2, the user can register the alighting planned station name 211, so as to memorize it into the memory portion 21 of the portable information terminal 2. Also, the alighting planned station name 211 maybe registered into the memory portion 21, directly, but without using the application for each route 210.

F2 is a sequence when the user gets on the car without reservation. In an emergency when the terminal communicator portion 20 cannot have a time sufficient for communicating with the communicator portion 10 of the bus stop sign 1, but it can receive the application for each route 310 from the entrance communicator portion 30 of the bus, in case where the entrance communicator portion 30 is provided on the bus 3. At the same time, it is also possible to receive at least one of the boarding determined station name 311 and the vacant seat forecast information 312 of the bus, which the user rides on.

Also, it is possible to prevent the user from mistake when boarding, which will be mentioned below. In such a bus stop where the buses of plural routes or lines arrive at and depart from the same stop, in the case when the user obtained the public transportation facility ID from the bus stop communicator portion 10 or the like, i.e., other than the entrance communicator portion 30, and stored it into the memory portion 21 of the portable information terminal 2 to be the public transportation facility ID 216, and when the received public transportation facility ID 216 of the route and the public transportation facility ID 313 of the bus which the user rides on, are different from, then that effect is noticed to the user, through noticing it to the portable information terminal 2, displaying it on the display portion of the bus, or through voices; therefore, it is possible to prevent the user from making a mistake of boarding on the bus of the route differing from that of the object of the user, at the time when she/he ride on.

Also, in the case when the user has registered the alighting planned station name 211 by the alighting planned bus top registering means mentioned above, before she/he rides on the bus 3, it is possible to inhibit a mistake of boarding, which will be mentioned below. For example, in case where the user rides on the bus B, being different in the terminal, but on the same route, and when the bus B will not arrive at or reach up to the alighting planned station 211, the effect that the bus will not arrive at that is noticed to the user when she/he rides on the car; therefore, it is possible to notice the mistake of boarding on the bus route mentioned above, and to inhibit a mistake of boarding, in the similar manner. Further, though not on the same or correct route, but in case where the alighting planned station name 211 stored is included within the stooping stations of the bus B, on which the user rides on mischievously, then it is also possible to notice the effect that she/he can arrive at the object station to the user.

Further, for example, on the route bus of adopting a variable fare system depending on traveling distance therein, it is possible to inhibit an unfair operation on the fare, as will be mentioned below. Not riding on the bus corresponding thereof at a bus stop where the user receives the application for each route, but if the user rides thereon from other bus stop of the same route while keeping it in the memory portion 21 of the portable information terminal 2 as the application 210, then the fare comes down to be cheap unfairly. For the purpose of protecting from this, the boarding planned station name 212 is transmitted to the entrance communicator portion 30 through the terminal communicator 20. The entrance communicator portion 30 transmits it to the communicator portion 40 of the information processing apparatus 4, so as to make comparison on the boarding planned station name 212 received and the present stopping bus stop name 411, and if they are coincident with, notice or display is made about the effect of being error. Or alternatively, it is possible to protect the fare from being operated unfairly, by transmitting the correct application for each route 310 to the terminal communicator portion 20, so as to renew the application for each route 210 memorized in the portable information terminal 2.

F10 is a sequence when the user takes a seat without reservation. As was mentioned in F1 mentioned above, since the alighting planned station name 211 can be registered, and in the case when registering it, it can be transmitted to the seat communicator portion 32 through the terminal communicator portion 20. Then, the seat communicator portion 32 transmits it to the communicator portion 40, so as to store it into the memory portion 41 to be the alighting planned station name 413. At the same time, it is stored in the seat communicator portion 32 in combination with the unique seat position information 419.

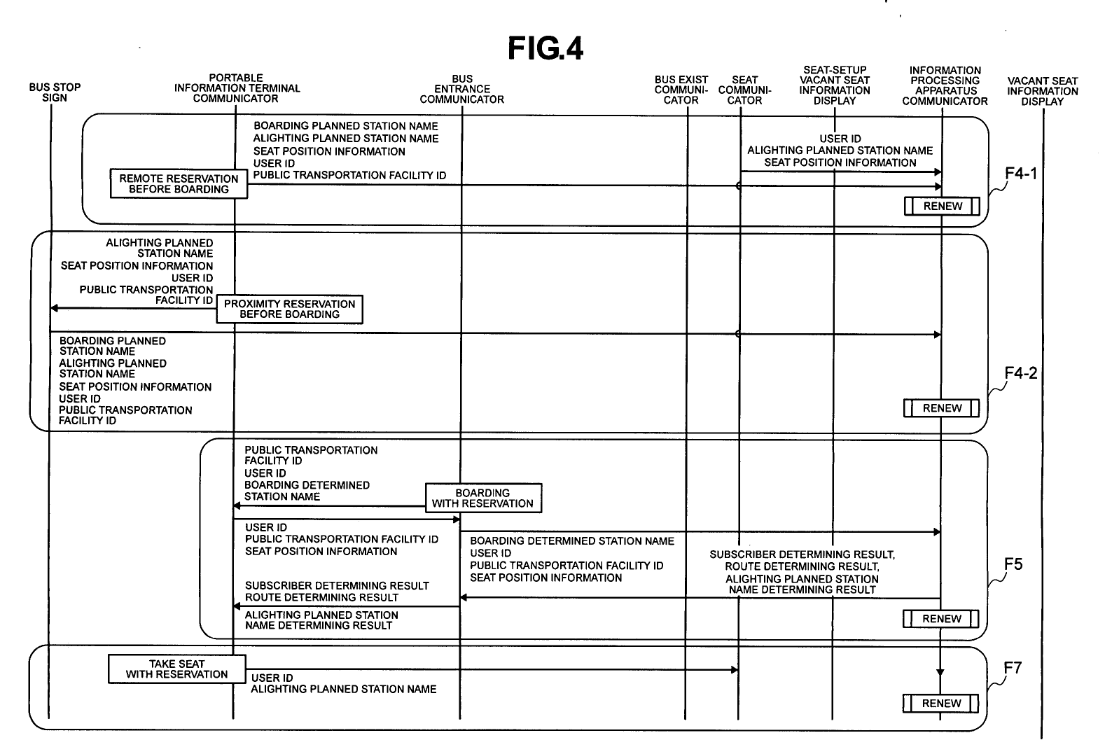

FIG. 4 shows sequences F4-1 and F4-2 in the pre-boarding reservation S4, a sequence F5 when boarding after having reservation, and a sequence F7 in sitting S7 on the seat that have being reserved.

F4-1 is a sequence for conducting the pre-boarding reservation through remote communication. The reservation for a vacant seat can be conducted from an outside of a car, before the user boards on the car, in the following manner. First of all, the user receives the application for each route 210 through the communicator portion 20 of the portable information terminal 2, so as to store it into the memory portion 21. And, with using the application for each route 210, into which the alighting planned station name 211 has being registered by the alighting planned station name registering means, the user confirm the vacant seat forecast information 213 on the bus 3, and makes selection on a seat to be reserved. The seat, on which the user can make reservation, may be either a present vacant seat or a future vacant seat. When selecting a certain seat on the application for each route 210, the communicator portion 20 of the portable information terminal 2 transmits at least any one of the user ID 215, the boarding planned station name 212, the alighting planned station name 211, the public transportation facility ID 216 and the seat position information 2111, which will be mentioned below, to the communicator portion 40 of the information processing apparatus 4 as the reservation information. The pre-boarding reservation process is conducted by making the reservation for a seat coincident with the seat position information, with using those information which the communicator portion 40 of the information processing apparatus 4 receives, and it advances into the renewing process F12.

F4-2 is a sequence for conducting the pre-boarding reservation through the proximity communication. This sequence is almost similar to the F4-1 mentioned above, but differs from it in the following aspects. Among the reservation information mentioned above, there is no necessity of registering the boarding planned station name 212 into the terminal memory portion 21, if it is the bus stop being same to that 110 receiving the application for each route. The reservation information is transmitted, not to the communicator portion 40, but to the bus stop communicator portion 10, at first. Then, the boarding planned station name 111 stored in the bus stop memory portion 11 is added to the reservation information, and the information is transmitted to the communicator portion 40. Others than that are same to those of the F4-1.

F5 is a sequence when the user rides on with having reserved the seat. The sequence relating to the protection of the user from the mistake in boarding is similar to that of the F2 mentioned above.

It is also possible to determine a subscriber in the manner as will be mentioned below. In case when the reservation is made before the boarding, as was mentioned in the F4-1 or F4-2, the boarding planned station name 212, the user ID 215, the public transportation facility ID 216, and the seat position information 2111 within the terminal memory portion 21 are already stored into the memory portion 40 of the information processing apparatus 4. The user transmits the information mentioned above to the entrance communicator portion 30 through the terminal communicator portion 20 when she/he rides on, and thereby determining on whether they agree or not with the boarding planned station name 415, the user ID 417, the public transportation facility ID 418 and the seat position information, which are stored within the memory portion 41, respectively. A result of this determination is transmitted to the entrance communicator portion 30 through the communicator 40, and is transmitted further to the terminal communicator portion 20. Through outputting the determination result received on the terminal display portion 22, thereafter, for the user, it is possible to make a confirmation on whether the bus she/he rides on and the bus on which the seat is reserved are consistent with or not. Herein, if the user who plans boarding does not rides on at the boarding planned station 415, which the memory portion 41 stores it therein, the reservation of that user is cancelled, and the sequence advances into the renewing process F12, for the purpose of renewing the vacant seat forecast information 410.

F7 is a sequence when the user takes the seat with having reserved that seat. The user who has reserved the seat from an inside of the car, or an outside of the car, transmits the user ID 215 to the seat communicator portion 32, which is provided at the seat to be taken through the terminal communicator 20. The seat communicator portion 32 transmits the user ID 215 received to the communicator portion 40 of the information processing apparatus 4. The information processing apparatus 4 compares the seat position information and the user ID 215 unique to the seat communicator portion 32, to which the user ID 215 is transmitted, and the seat position information and the user ID 417, which are stored as the reservation information, respectively. As a result of comparison, if they are same, it is decided that taking a seat is completed, and the sequence advances into the renewing process F12. At the same time, as shown in F10, it is possible to transmit the alighting planned station name 211.

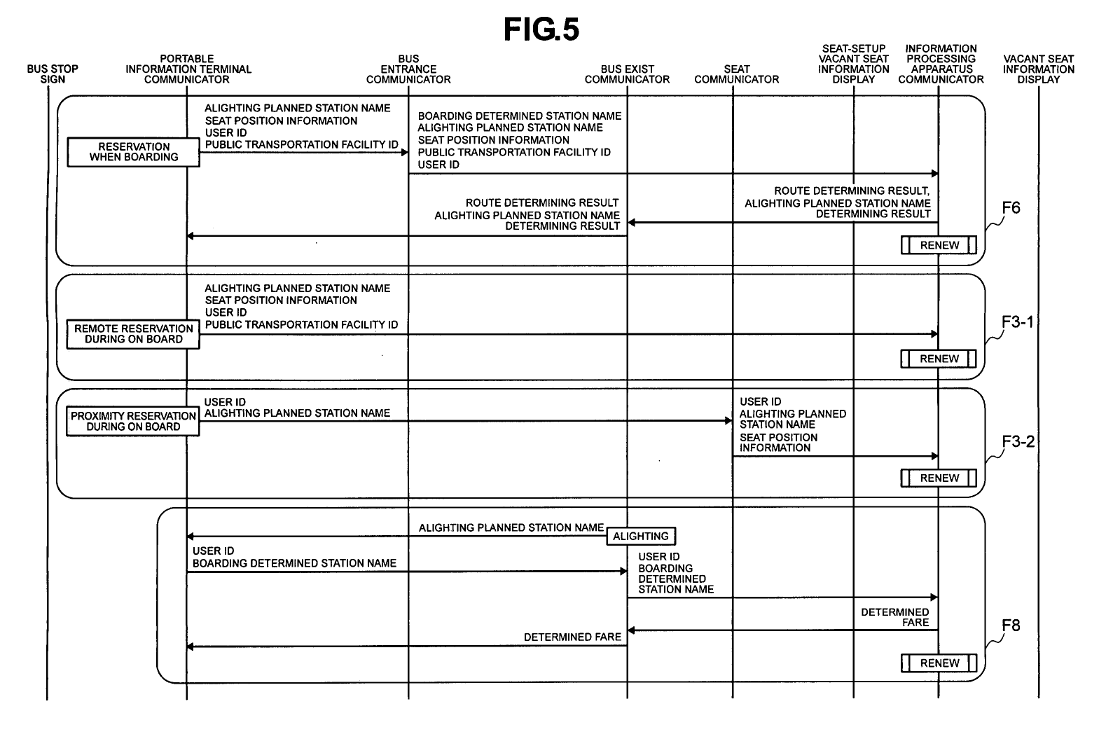

FIG. 5 show therein a sequence F6 in the reservation when boarding S6, sequences F3-1 and F3-2 in the reservation on board S3, and a sequence F8 when alighting S8.

F6 is a sequence when the user makes reservation for a seat at the same time when she/he rides on. Explanation will be made on a method for the user makes reservation for a seat at the same time when she/he rides on. In the similar manner to those of the pre-boarding reservation F4-1 and F4-2 mentioned above, the user before boarding receives the vacant seat forecast information 113 or 410 from the bus stop communicator portion 10 or the communicator portion 40 of the information processing terminal 4, and stores it into the memory portion 21 to be the application for each route 210 therein. And, the user confirms the vacant seat forecast information 213 on the bus 3 with using the application for each route 210, into which the alighting planned station name 211 is registered by the alighting planned station name registering means mentioned above, and selects a seat to be reserved. In case where it is impossible to keep the time sufficient for transmitting the reservation information to the communicator portion 40 of the information processing terminal 4, to be conducted before the boarding of F4-1 or F4-2 mentioned above, it is also possible to transmit the alighting planned station name 211 and the position information 2111 of the reserved seat to the bus entrance communicator portion 30 when boarding. Then, the bus entrance communicator portion 30 transmits those information to the communicator portion 40 of the information processing terminal 4, thereby to store them into the memory portion 41 to be the alighting planned station name 413 and the seat position information 419; then the sequence completing the reservation process when boarding. The sequence further advances into renewing process F12. However, notice of the mistake in boarding in FIG. 6 is same to that in F2.

F3-1 is a sequence of conducting the reservation for a seat through a remote communication on board. The method for reserving the vacant seat from remote within the bus, with using the application for each route 210, is almost similar to that of the sequence F4-1 for pre-boarding reservation. An aspect differing from lies in that the boarding planned station name is determined since the user is already on board. Therefore, among the reservation information shown in F4-1, the boarding planned station name is unnecessary, but other than that may be the sequence similar to the F4-1. However, it is also possible to conduct the alighting planned station name registration and transmission thereof, shown in the F1, herein.

F3-2 is a sequence for conducting the reservation for a seat through the proximity communication on board. The method for reserving the vacant seat by conducting the proximity communication with the seat communicator portion 32 is almost similar to the pre-boarding proximity reservation sequence F4-2. An aspect differing from is in that an object, to which the reservation information should be transmitted, is the seat communicator portion 32, and in that the reservation information may comprises only the user ID 215. However, it is also possible to conduct the alighting planned station name registration and the transmission thereof, shown in F1, herein.

F8 is a sequence when the user gets off the car. When the user gets of f the car, the terminal communicator portion 20 receives the present stopping station name 311 from the exit communicator portion 35, and within the terminal memory portion 21, it is stored to be the alighting determined station name 218. The fare calculator means A4 calculates the fare, with using the boarding determined station name 217 and the alighting determined station name 218. Also, the exit communicator portion 35 receiving the user ID 215 transmits it to the communicator portion 40, and the fare is calculated, with using the boarding determined station name 416 relating to the user ID 215 consistent with the user ID 215, and using the present stopping station name 411 to be the alighting determined station name 414. Further, in case when other user does not conduct the seat taking process F7 or F10, with respect to the seat position information 419 relating to the user ID 417 mentioned above, it is possible to determine that the seat is vacant. Also, in case if the exit communicator portion 35 receives the boarding determined station name 2-17, in the similar manner to that mentioned above, the fare is calculated with using the present stopping station name 411 to be the alighting determined station name 414. A result of this fare calculation is outputted onto the terminal display portion 22 or the fare display portion 37, as the settled fare, and this can be subtracted from an amount of money stored within the terminal memory portion 21. After completing this alighting process, the sequence advances into the renewing process F12.

With carrying out in accordance with the sequences mentioned above, the bus user can obtain the vacant seat forecast information from remote or in proximity, and also can reserve a vacant seat. Further, it is also possible to promote the goodwill to open the information relating alighting to the public. Finally, it can be easily diverted into other routes or lines.

The present invention may be embodied in other specific forms without departing from the spirit or essential feature or characteristics thereof. The present embodiment(s) is/are therefore to be considered in all respects as illustrative and not restrictive, the scope of the invention being indicated by the appended claims rather than by the forgoing description and range of equivalency of the claims are therefore to be embraces therein.

What is claimed is:

1. A vacant seat reservation system, for reserving a seat of a public transportation facility, like a bus, comprising:
a portable information terminal having alighting planned station name register means for registering an alighting planned station name into a terminal memory portion, and means for reading out the alighting planned station name from said terminal memory portion, so as to transmitting it through a terminal communicator portion;
a communicator portion for receiving the alighting planned station name; and
a display portion for displaying the alighting planned station name thereon.

2. The vacant seat reservation system, as defined in the claim 1, further comprising:
a portable information terminal, having an alighting planned station name registering means for registering an alighting planned station name therein, and a communicator portion for transmitting the alighting planned station name registered into said alighting planned station name registering means;
a communicator portion for receiving the alighting planned station name; and
a display portion for displaying the alighting planned station name thereon, whereby providing information for forecasting a vacant seat.

3. The vacant seat reservation system, as defined in the claim 1, wherein said display portion is provided, at least any one of positions, in an inside of a bus, in an outside of the bus, of each seat in the bus, or of said portable information terminal.

4. The vacant seat reservation system, as defined in the claim 3, further comprising:
an information processing apparatus, having a stopping station name detecting means for detecting a stopping station name, which the bus is new stopping or passed through just before, and an arrival time estimating means for calculating an arrival estimation time up to the alighting planned station name, separately, with using the alighting planned station name that said stopping station name detecting means and said communicator portion receive, wherein said display portion display said arrival estimation time thereon.

5. The vacant seat reservation system, as defined in the claim 4, further comprising:
an information processing apparatus having an individual boarding/alighting information integrating means for generating vacant seat forecast information by integrating the alighting planned station name relating to each of the seat of the bus and the arrival estimation time, in relation to all of the seats within a specific area, and an alighting order calculating means for calculating an order of becoming vacant for the vacant seat forecast information, relatively, wherein the order is transmitted through a communicator portion of said information processing apparatus, so that said order is displayed on said display portion.

6. The vacant seat reservation system, as defined in the claim 4, further comprising:
a portable information terminal having an alighting planned station name registering means for registering the alighting planned station name therein, a communicator for receiving route stopping station names of the bus, and an output portion for outputting an audio or information; and
an alighting planned station stoppage deciding means for deciding on whether the said alighting planned station name is included or not, within stations that the boarding bus stops at, by comparing the alighting planned station name, which is registered by said alighting planned station name registering means, and the route stopping station names of the bus, which is received through said communicator portion, wherein a result of said alighting planned station stoppage deciding means is outputted on said output portion.

7. The vacant seat reservation system, as defined in the claim 6, wherein said information processing apparatus has a communicator portion for receiving the alighting planned station name registered in said portable information terminal, a memory portion for storing the route stopping station names of the bus, and an alighting planned station stoppage deciding means for deciding on whether the said alighting planned station name received through said communicator portion is included or not, within the route stoppage station names stored within said memory portion, wherein a result of said alighting planned station stoppage deciding means is transmitted through said communicator portion of said information processing apparatus or is outputted on said display portion of the bus.

8. The vacant seat reservation system, as defined in the claim 3, wherein said communicator portion for receiving the alighting planned station name is provided, at least any one of a bus stop, a bus entrance, the seats within the bus, or said information processing apparatus.

9. The vacant seat reservation system, as defined in the claim 8, wherein the alighting planned station name registering means is transmitted by at least any one of the bus stop, the bus entrance, the seats in the bus, said information processing apparatus, or a computer on a network, and is received by said portable information terminal.

10. The vacant seat reservation system, as defined in the claim 1, further comprising:
a portable information terminal having a boarding planned station name registering means for registering a boarding planned station name into said terminal memory portion, and a means for reading out the boarding planned station name from said terminal memory portion to transmit it through said terminal communicator portion;
a communicator portion for receiving the boarding planned station name; and
a display portion for displaying the boarding planned station name thereon.

11. The vacant seat reservation system, as defined in the claim 10, wherein said display portion is provided, at least any one of positions, in an inside of a bus, in an outside of the bus, of each seat in the bus, or of said portable information terminal.

12. The vacant seat reservation system, as defined in the claim 11, wherein said portable information terminal further comprises an alighting planned station name registering means fore registering the alighting planned station name therein, and a fare calculating means for calculating a fare necessary for riding from the boarding planned station to the alighting planned station, and said portable information terminal calculates the fare by said fare calculating means to be outputted on the display portion.

13. The vacant seat reservation system, as defined in the claim 12, further comprising an information processing apparatus having a communicator portion, wherein said information processing means has a fare calculating means for calculating a necessary fare relating to riding of a section, from a start point determined to be either the boarding planned station name received through said communicator portion, or that of a stopping station name detecting means for detecting a station name, which the bus is now stopping at or the bus passed through just before, to an end point determined to be the alighting planned station name received through said communicator portion, or an alighting determined station name obtained by said stopping station name detecting means, wherein the fare calculated by said fare calculating means is transmitted through said communicator portion, or displayed on a display portion.

14. The vacant seat reservation system, as defined in the claim 11, wherein said portable information terminal comprises a vacant seat reservation means for transmitting a user ID enabling to uniquely identify a bus user, through said terminal communicator portion to the communicator portion of said information processing apparatus, and further depending upon necessity thereof, transmitting at least one of a public transportation facility ID enabling to uniquely identify a bus, on which seat reservation is made, a seat position information enabling to uniquely discriminate a seat, or the boarding planned station name registered by said boarding planned station name registering means, through the communicator portion of said portable information terminal to the communicator portion of said information processing apparatus, thereby conducting reservation for a seat.

15. The vacant seat reservation system, as defined in the claim 14, wherein said information processing apparatus comprises a seat reservation display means for receiving said boarding planned station name, said public transportation facility ID and said seat position information, through said communicator portion, wherein said display portion displays the boarding planned station name about the seat corresponding to said seat position information, if said public transportation facility ID stored in said memory portion is same to said public transportation facility ID received upon comparison thereof, or displays an effect that the reservation is made, while storing said user ID into said memory portion.

16. The vacant seat reservation system, as defined in the claim 14, wherein said portable information terminal comprises an output portion for outputting an audio and/or information, and a route determining means for determining on whether the bus that the user will ride on provides a facility same to that the user intends to ride on, or is that of the same route, wherein a result of said route determining means is outputted to an output portion of said portable information terminal or said display portion.

17. The vacant seat reservation system, as defined in the claim 16, wherein said information processing apparatus comprises a route determining means for comparing the public transportation facility ID received through said communicator portion and the public transportation facility ID stored in the memory portion of said information processing apparatus, wherein a result of said route determining means is transmitted to the communicator of said portable information terminal through the communicator portion, or is outputted to the display portion.

18. The vacant seat reservation system, as defined in the claim 13, wherein said information processing apparatus comprises a user determining means for receiving said user ID through the communicator, so as to determine on whether it is coincident with the user ID stored in said memory portion, wherein a result of said determination is transmitted through the communicator, or said determination is displayed on said display portion.

19. The vacant seat reservation system, as defined in the claim 18, wherein said information processing apparatus comprises an application producing means for producing an application installing therein, at least one of vacant seat forecast information, which is produced said individual boarding/alighting integrating means, alighting order, which is calculated by said alighting order calculating means, said public transportation facility ID, said alighting planned station name registering means, said boarding planned station name registering means, said fare calculating means, said route determining means, and said alighting planned station stoppage determining means, whereby renewing the application produced by said application producing means, or present condition data to be used by said application, and distributing said application or said present condition data through said communicator portion.

20. The vacant seat reservation system, as defined in the claim 19, wherein said portable information terminal comprises an application executing means for executing said application, a present condition obtaining means for receiving said application or said present condition data through the communicator portion of said portable information terminal, whereby executing said application renewed, or renewing an output on the display portion by using said present condition data renewed.

21. The vacant seat reservation system, as defined in the claim 20, wherein said information processing apparatus renews either said vacant seat forecast information or said present condition data, at least one of instances when the user makes the seat reservation, cancels the reservation, takes a seat, leaves the seat, rides on the bus, gets off the bus, depending on distance which the bus travels, or accompanying with elapsing of traveling time, and the communicator portion of said information processing apparatus transmits said vacant seat forecast information or said application, which is renewed.
